(19) United States
(12) Patent Application Publication
(10) Pub. No.: US 2012/0021135 A1
(43) Pub. Date: Jan. 26, 2012

(54) METHOD OF MANUFACTURING EYEGLASS LENS

(75) Inventor: Eiichi YAJIMA, Shinjuku-ku (JP)

(73) Assignee: HOYA CORPORATION, Tokyo (JP)

(21) Appl. No.: 13/154,605

(22) Filed: Jun. 7, 2011

(30) Foreign Application Priority Data
Jun. 8, 2010 (JP) 2010-130721

(51) Int. Cl. B05D 5/06; B05D 3/02; B05D 3/00; B05D 3/06

(52) U.S. Cl. 427/521; 427/164; 427/163.1

(57) ABSTRACT

An aspect of the present invention relates to a method of manufacturing an eyeglass lens comprising a primer layer and a hardcoat layer in this order on a substrate, which comprises coating a waterborne resin composition in which a resin component is dispersed or dissolved in a water-based solvent on the substrate and then removing the water-based solvent to form the primer layer; and directly coating a hardcoat liquid comprising a curable component and a solvent on the primer layer that has been formed and then conducting a curing process to form the hardcoat layer. An exclusion range including solubility parameter SP1 of the waterborne resin composition is set and a solvent having a solubility parameter outside the exclusion range that has been set is utilized for preparing the hardcoat liquid.

### CROSS-REFERENCE TO RELATED APPLICATIONS

This application claims the benefit of priority under 35 USC 119 to Japanese Patent Application No. 2010-130721 filed on Jun. 8, 2010, which is expressly incorporated herein by reference in its entirety.

### BACKGROUND OF THE INVENTION

1. Field of the Invention

The present invention relates to an eyeglass lens, and more particularly, to an eyeglass lens in which there is good adhesion between a hardcoat layer and a primer layer.

2. Discussion of the Background

Normally, functional films are formed on an eyeglass lens to impart various functions. Examples of functional films are polarizing films imparting polarizing functions and photochromic films imparting light-adjusting performance.

Generally, these functional films are not tough enough to withstand extended periods of use on the outermost surface of a lens. Thus, a hardcoat layer is often formed over such films. For example, Examples of Published Japanese Translation (TOKUHYO) No. 2008-527401 of a PCT International Application or English language family members US2006/146234 A1, U.S. Pat. No. 7,625,626, US2010/028532A1, and U.S. Pat. No. 7,922,847, and WO 2008/106034 or English language family members US2008/206577 and US2010/060984A1, which are expressly incorporated herein by reference in their entirety, describe the formation of hardcoat layers in the form of an acrylic base scratch-resistant coating over a polarizing film. Further, Examples of Japanese Unexamined Patent Publication (KOKAI) No. 2009-237361 or English language family member US2011/102892A1, which are expressly incorporated herein by reference in their entirety, describe the formation of a hardcoat layer using an ultraviolet-curable resin over a polarizing film.

Forming a hardcoat layer on an eyeglass lens as set forth above can impart scratch resistance and shock resistance to increase durability. However, when there is poor adhesion between the hardcoat layer and the layer beneath it, the hardcoat layer ends up peeling off or separating from the lens during storage or use.

Accordingly, to increase adhesion of the hardcoat layer, it is conceivable to form a primer layer capable of functioning as an adhesive layer, and then form a hardcoat layer over the primer layer. In recent years, waterborne resin compositions have been proposed as coating liquids capable of forming such primer layers (for example, see Japanese Patent No. 3,588,375, and Japanese Unexamined Patent Publication (KOKAI) Heisei Nos. 8-34897, 11-92653, and 11-92655, which are expressly incorporated herein by reference in their entirety).

These waterborne resin compositions are compositions in which a resin component is dispersed or dissolved in an water-based solvent. After coating the composition, it is dried or the like to remove the solvent, thereby forming a resin layer capable of functioning as an adhesive layer.

Accordingly, when the present inventor formed a hardcoat layer over a primer layer comprised of an waterborne resin composition with the object of increasing the adhesion of the hardcoat layer, he found that adequate adhesion between the hardcoat layer and the primer layer could not always be ensured.

### SUMMARY OF THE INVENTION

An aspect of the present invention provides for a highly durable eyeglass lens in which there is good adhesion between a hardcoat layer and a primer layer.

The present inventor conducted extensive research into achieving the above object, resulting in the discovery that by using a hardcoat liquid containing a solvent having a solubility parameter (also referred to as an “SP value”, hereinafter) in the vicinity of that of the waterborne resin composition employed to form the primer layer, the adhesion of the hardcoat layer and primer layer became inadequate and the durability of the eyeglass lens decreased. It has previously been reported that the closer the SP value of the object being coated to that of the solvent employed in the coating liquid, the better the adhesion (see, for example, Japanese Unexamined Patent Publication (KOKAI) No. 2001-279184, which are expressly incorporated herein by reference in their entirety). However, it is novel knowledge that was first discovered by the present inventor that the closer the SP values of the coating liquid (waterborne resin composition) used to form the object being coated and the solvent employed in preparing the coating liquid, the more inadequate the adhesion.

The present inventor devised the present invention as a result of extensive research based on the above discovery.

An aspect of the present invention relates to a method of manufacturing an eyeglass lens comprising a primer layer and a hardcoat layer in this order on a substrate, which comprises:

coating a waterborne resin composition in which a resin component is dispersed or dissolved in a water-based solvent on the substrate and then removing the water-based solvent to form the primer layer; and

directly coating a hardcoat liquid comprising a curable component and a solvent on the primer layer that has been formed and then conducting a curing process to form the hardcoat layer; and further comprises:

setting an exclusion range including solubility parameter SP 1 of the waterborne resin composition and utilizing a solvent having a solubility parameter outside the exclusion range that has been set for preparing the hardcoat liquid.

A solvent having a solubility parameter that is lower than the exclusion range may be utilized as the solvent for the preparation of the hardcoat liquid

The exclusion range may be set to a range of SP1±X, wherein 1≦X≦2.

The curable component may be a photo-curable component and the curing process may be conducted by irradiation with light.

A polarizing layer may be formed on the substrate and then the primer layer may be formed on the polarizing layer.

The present invention can provide an eyeglass lens of good durability.

### BRIEF DESCRIPTION OF THE DRAWINGS

FIG. 1 is a descriptive drawing of the layer structure of the polarizing lens prepared in Examples.

FIG. 2 shows the relation between the SP value of the solvent employed to prepare the hardcoat liquid in Examples and the SP value of the waterborne polyurethane resin composition employed to form the primer layer.

### DETAILED DESCRIPTION OF THE EMBODIMENTS

The present invention relates to a method of manufacturing an eyeglass lens comprising a primer layer and a hardcoat layer in this order on a substrate. The method of manufacturing an eyeglass lens of the present invention comprises coating a waterborne resin composition in which a resin component is dispersed or dissolved in a water-based solvent on the substrate and then removing the water-based solvent to form the primer layer; and directly coating a hardcoat liquid comprising a curable component and a solvent on the primer layer that has been formed and then conducting a curing process to form the hardcoat layer. Further, an exclusion range including solubility parameter SP1 of the waterborne resin composition is set and a solvent having a solubility parameter outside the exclusion range that has been set is utilized for preparing the hardcoat liquid.

In the present invention, by employing the criterion of having a solubility parameter differing from the solubility parameter of the waterborne resin composition to select the solvent employed to prepare the hardcoat liquid, it becomes possible to obtain an eyeglass lens in which there is good adhesion between the hardcoat layer and the primer layer. As set forth above, this fact is based on novel knowledge that was previously unknown.

The method of manufacturing an eyeglass lens of the present invention will be described in greater detail.

### Substrate

The waterborne resin composition for forming the primer layer can be directly coated on the substrate, or can be coated on the substrate over an intervening layer. The intervening layer that can be formed will be described further below.

The substrate is not specifically limited; examples are plastics and inorganic glasses. Examples of plastics are: methyl methacrylate homopolymer; copolymers of methyl methacrylate and one or more other monomers; diethyleneglycol bisallylcarbonate homopolymer; copolymers of diethyleneglycol bisallylcarbonate and one or more other monomers; iodine-containing copolymers; halogen copolymers; polymers comprised of materials in the form of polycarbonates, polystyrenes, polyvinyl chlorides, unsaturated polyesters, polyethyleneterephthalates polyurethanes, polythiourethanes, and compounds having epithio groups; homopolymers of monomers having sulfide bonds; copolymers of a sulfide and one or more other monomer; copolymers of a polysulfide and one or more other monomers; and copolymers of a polydisulfide and one or more other monomers. The thickness of the substrate is not specifically limited. In an ordinary eyeglass lens, the thickness is about 1 to 30 mm. Nor is the surface shape of the substrate on which the primer layer and hardcoat layer are sequentially deposited specifically limited; the surface can be of any shape, such as planar, convex, or concave.

### Waterborne Resin Composition, Primer Layer

The waterborne resin composition that is employed to form the primer layer in the present invention is a coating composition in which a resin component is dispersed or dissolved in an water-based solvent.

From the perspective of adhesion, the thickness of the primer layer that is formed of the waterborne resin composition is desirably equal to or greater than 0.05 μm. From the perspective of the optical characteristics of the eyeglass lens obtained, it is desirably equal to or less than 0.5 μm. From the perspective of achieving both optical characteristics and adhesion, it desirably falls within a range of from 0.10 to 0.45 μm.

The water-based solvent that is contained in the waterborne resin composition is, for example, water or a mixed solvent of water and a polar solvent, and is desirably water. From the perspective of the liquid stability and film-forming properties, the solid component concentration in the waterborne resin composition is desirably 1 to 62 mass percent, preferably 5 to 38 mass percent. In addition to the resin component, the waterborne resin composition can contain as needed additives such as oxidation inhibitors, dispersants, and plasticizers. A commercially available waterborne resin composition can be diluted in a solvent such as water, alcohol, or propyleneglycol monomethylether (PGM) for use.

The waterborne resin composition can contain a resin component dissolved in a water-based solvent or in the form of microparticles (desirably colloidal particles) dispersed therein. It is desirably a dispersion comprising a resin component in the form of microparticles dispersed in a water-based solvent (desirably in water). In that case, from the perspective of the dispersion stability of the composition, the diameter of the resin component is desirably equal to or less than 0.3 μm. The pH of the waterborne resin composition at 25° C. is desirably about 5.5 to 9.0 from the perspective of stability. From the perspective of coating suitability, the viscosity at 25° C. is desirably 5 to 500 mP·s, preferably 10 to 50 mP·s. Taking into account the physical properties of the waterborne resin layer that is formed, a waterborne resin composition having the following film characteristics is desirable: a coating film, obtained by forming a coating to a thickness of 1 mm on a glass sheet and drying it for one hour at 120° C., with a glass transition temperature Tg of −58° C. to 7° C., a pencil hardness of 4 B to 2 H, and a tensile strength as measured in accordance with JIS K7113 of 15 to 69 MPa.

Examples of the resin component of the waterborne resin composition are polyurethane resins, acrylic resins, and epoxy resins. From the perspective of adhesion, a polyurethane resin is desirable as the resin component. A waterborne resin composition containing a polyurethane resin, that is, a waterborne polyurethane resin composition, can be prepared by subjecting, for example, a high-molecular-weight polyol compound and an organic polyisocyanate compound to a urethane-forming reaction in a solvent that is inert with respect to the reaction and has good compatibility with water, with a chain-extending agent, as needed, to obtain a prepolymer. The prepolymer is neutralized and then dispersed in a water-based solvent containing a chain-extending agent to achieve a high molecular weight. For example, reference can be made to paragraphs [0009] to [0013] of Japanese Patent No. 3,588,375; paragraphs [0012] [0021] of Japanese Unexamined Patent Publication (KOKAI) Heisei No. 8-34897; paragraphs [0010] to [0033] of Japanese Unexamined Patent Publication (KOKAI) Heisei No. 11-92653; and paragraphs [0010] to [0033] of Japanese Unexamined Patent Publication (KOKAI) Heisei No. 11-92655 for such waterborne polyurethane resin compositions and methods of preparing them. The contents of the above applications are expressly incorporated herein by reference in their entirety. A commercially available waterborne polyurethane can be employed as is, or diluted with a water-based solvent as needed, as the aqueous polyurethane resin composition. Examples of commercially available waterborne polyurethanes that are suitable for use are the “Adeka Bontighter” series made by Asahi Denka Kogyo, K. K.; the “Olester” series made by Mitsui Toatsu Chemicals, Inc.; the “Vondic” series and “Hydran” series made by Dainippon Ink and Chemicals Corporation; the “Impranil” series made by Bayer; the “Soflanate” series made by Nippon Soflan; the “Poiz” series made by Kao Corporation; the “Sanprene” series made by Sanyo Chemical Industries, Ltd.; the “Izelax” series made by Hodogaya Chemical Co., Ltd.; the “Superflex” series made by Daiichi Yakuhin Kougyou Co., Ltd.; and the “NeoRez” series made by Zeneca Resins.

A waterborne polyurethane resin composition obtained by dispersing in a water-based solvent a terminal isocyanate prepolymer having an anionic group such as a carboxyl group or sulfonic group and having a basic skeleton in the form of polyol such as a polyester polyol or polyether polyol.

The primer layer can be formed by coating the waterborne resin composition on a substrate and then removing the water-based solvent. A known coating method, such as dipping or spin coating, can be employed as the method of coating the waterborne resin composition. The coating conditions can be suitably established so as to form a primer layer of desired film thickness. Before applying the coating, the surface to be coated (substrate surface or the like) can be chemically treated with acids, alkalis, and various organic solvents or the like; physically treated with plasma, UV radiation, ozone, or the like; or cleansed with any of various cleansing agents. Such preprocessing can enhance adhesion between the surface being coated and the primer layer. To enhance adhesion, it is effective to subject the entire lens to a heat treatment (annealing) prior to applying the coating. The reason why such heating can increase adhesion is thought to be that the state of the surface being coated is modified so that it readily bonds with or adsorbs the functional groups of the resin component in the waterborne resin composition. For example, the above heat treatment can be conducted by placing the entire lens, prior to coating, in a heating furnace in which the temperature is regulated to about 40 to 80° C. for about five minutes to one hour. Following the heat treatment, cooling can be conducted to stabilize the film thickness during coating of the primer liquid. The above cooling treatment can be conducted by removing the material to the exterior of the furnace following heating and allowing it to stand for a certain period so that it returns to ambient temperature.

The water-based solvent can be removed following coating by, for example, placing the lens on which the primer layer has been formed in an atmosphere of from ambient temperature to 100° C. for from 5 minutes to 24 hours (a drying step). Here, it is not necessary to completely remove the water-based solvent; it suffices to remove the solvent to a degree at which the coating (primer layer) that has been formed attains a suitable hardness. As set forth further below, the hardcoat layer is formed by means of a curing process. When the primer layer is also formed by means of a curing process, separate curing processes are required to form the primer layer and hardcoat layer. By contrast, since a waterborne resin composition normally does not contain a curable component, the film can be formed without a curing treatment such as heating or irradiation with light. This is extremely advantageous from the perspective of simplifying the manufacturing process.

### Hardcoat Liquid, Hardcoat Layer

The hardcoat liquid is directly coated on the primer layer that has been formed by the above method. The hardcoat liquid contains a curable component and a solvent. Examples of solvents are aliphatic hydrocarbons such as hexane and octane; aromatic hydrocarbons such as toluene and xylene; alcohols such as ethanol, 1-propanol, isopropanol, and 1-butanol; ketones such as methyl ethyl ketone and methyl isobutyl ketone; esters such as ethyl acetate and butyl acetate; glycol ethers such as ethyleneglycol monoethylether acetate and propyleneglycol monomethylether acetate; cellosolves; and various mixtures thereof. In the present invention, a solvent having an SP value outside the exclusion range determined based on the SP value of the waterborne resin composition employed to form the primer layer is selected from among the above solvents and used to prepare the hardcoat liquid.
This point will be described in greater detail below.

The solubility parameter (SP value) is a yardstick of solubility. The SP values of known solvents are given in the known literature, such as handbooks. SP values that are not given in the known literature can be measured by known methods.

The following is one method that can be adated to measure the SP value. [Reference Document: Suh, Clarke, J. P. S. A-1.5, 1671-1681 (1967), which is expressly incorporated herein by reference in its entirety].

Measurement temperature: 20° C.

Sample: A 0.5 g of the substance to be measured is weighed out into a 100 mL beaker, and 10 mL of good solvent is added with a whole pipette and dissolved with a magnetic stirrer.

Solvent:

Good solvents: dioxane, acetone, and the like

Poor solvents: n-hexane, ion-exchanged water, and the like

Turbidity point measurement: the amount of drops at the point where turbidity occurs when using a 50 mL burette to add a poor solvent dropwise.

The SP value δ is given by the following equation:

δ=(Vₘₗ^{1/2}δₘₗ+Vₘₕ^{1/2}δₘₕ)/(Vₘₗ^{1/2}+Vₘₕ^{1/2})

Vₘ=V₁V₂/(φ₁V₂+φ₂V₁)

δₘ=φ₁δ₁+φ₂δ₂

Vi: molecular volume of the substance being measured

φi: Volume fraction of each substance being measured at the turbidity point

δi: SP value of the substance being measured

ml: mixed system of poor solvents of low SP

mh: mixed system of poor solvents of high SP

As set forth above, the present inventor discovered that a hardcoat layer formed using a hardcoat liquid prepared using a solvent having an SP value in the vicinity of the SP value (SP1) of the waterborne resin composition used to form the primer layer adhered poorly to the primer layer. Accordingly, in the present invention, an “exclusion range” including the SP value of the waterborne resin composition (SP1) is set; solvents having SP values within the exclusion range that has been set are not employed; and a solvent having an SP value outside the exclusion range is employed to prepare the hardcoat liquid. Thus, an eyeglass lens with good adhesion between the primer layer and the hardcoat layer can be obtained.

The exclusion range can be specified, for example, by adopting SP1 as the center value and specifying the range as SP1±X. Here, X can be determined by preliminary testing. Based on research by the present inventor, good adhesion between the hardcoat layer and the primer layer has been confirmed within a range of 1≦X≦2. Accordingly, a desirable example of the exclusion range is a range of SP1±X (1≦X≦2). It is not necessary to make SP1 the center value of the exclusion range; SP1 can be somewhat closer to the lower limit or upper limit of the exclusion range.

In one embodiment, the SP value of the solvent employed in the hardcoat liquid can be lower than the exclusion range, and in another embodiment, higher than the exclusion range. Although also depending on the SP value of the waterborne resin composition, the SP value of generally available waterborne resin compositions is about 10 to 12. Many of the solvents having SP values higher than the exclusion range determined on this basis are undesirable from the perspective of solubility of the resin component in the waterborne resin composition. Accordingly, in the present invention, solvents having an SP value lower than the exclusion range are desirably selected for use in preparing the hardcoat liquid.

When employing a waterborne resin composition with an SP value of about 10 to 12, an example of a suitable hardcoat liquid solvent is a solvent having an SP value of less than 9 of, for example, about equal to or higher than 7 but less than 9. Specific examples of such solvents are methyl isobutyl ketone (SP value: 8.10), propyleneglycol monomethylether acetate (SP value: 8.73), and ethyleneglycol monoethylether acetate (SP value: 8.91). However, as set forth above, the hardcoat liquid solvent employed in the present invention is selected based on the SP value of the waterborne resin composition that is employed to form the primer layer, and is not limited to the above specific examples. When employing a waterborne resin composition containing polyurethane resin as a resin component (a waterborne polyurethane resin composition), a solvent containing an acetyl group (CH₃(C=O)—) is desirably employed. This is because there is good compatibility between the urethane bond and acetyl bond, so a solvent containing an acetyl group will be well suited to application on a primer layer formed from a waterborne polyurethane resin composition.

The curable component contained in the hardcoat layer can be a photo-curable or thermosetting component. Generally, it is easier to ensure adhesion of a thermoset hardcoat layer than a photo-cured hardcoat layer. Accordingly, application of the present invention to a photo-cured hardcoat layer that tends not to adhere compared to a thermoset hardcoat layer is desirable.

A photo-curable hardcoat liquid that contains a polyfunctional acrylate compound as a curable component is desirable because it permits the formation of a hardcoat layer having good scratch resistance.

The above polyfunctional acrylate compound is a compound having at least two acryloyloxy groups or methacryloyloxy groups per molecule. Specific examples are ethyleneglycol diacrylate, diethyleneglycol diacrylate, 1,6-hexanediol diacrylate, neopentylglycol diacrylate, trimethylolpropane triacrylate, trimethylolethane triacrylate, tetramethylolmethane triacrylate, tetramethylolmethane tetraacrylate, pentaglycerol triacrylate, pentaerythritol triacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris(acryloyloxyethyl)isocyanurate, ethyleneglycol dimethacrylate, diethyleneglycol dimethacrylate, 1,6-hexanediol dimethacrylate, neopentylglycol dimethacrylate, trimethylolpropane trimethacrylate, trimethylolethane trimethacrylate, tetramethylolmethane trimethacrylate, tetramethylolmethane tetramethacrylate, pentaglycerol trimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate, dipentaerythritol hexamethacrylate, tris(methacryloyloxyethyl)isocyanurate, a phosphazene-based acrylate compound or phosphazene-based methacrylate compound in which an acryloyloxy group or methacryloyloxy group has been introduced onto the phosphazene ring of a phosphazene compound; a urethane acrylate compound or urethane methacrylate compound obtained by reacting a polyisocyanate having at least two isocyanate groups in the molecule with a polyol compound having at least one acryloyloxy group or methacryloyloxy group and a hydroxyl group; a polyester acrylate compound or polyester methacrylate compound, obtained by reacting with polyol compound having at least two carboxylic acid halides per molecule as well as at least one acryloyloxy group or methacryloyloxy group and a hydroxyl group; and dimers, trimers, and other oligomers and the like of the above compounds.

These compounds can be employed singly or in combinations of two or more. In addition to the above polyfunctional (meth) acrylates, at least one monofunctional (meth) acrylate selected from the group consisting of hydroxyethyl (meth) acrylate, 2-hydroxyethyl (meth) acrylate, 2-hydroxypropyl (meth)acrylate, hydroxybutyl (meth) acrylate, 2-hydroxy-3-phenoxypropyl (meth) acrylate, and glycidyl (meth) acrylate can be compounded, desirably in a proportion of equal to or less than 10.0 mass percent relative to the solid component during curing of the hardcoat liquid.

A polymerizable oligomer can be added to the hardcoat liquid to adjust the hardness of the hardcoat layer that is formed. Examples of such oligomers are terminal (meth) acrylate polymethylmethacrylate, terminal styryl poly(meth)acrylate, terminal (meth)acrylate polystyrene, terminal (meth)acrylate polyethyleneglycol, terminal (meth)acrylate acrylonitrile-styrene copolymers, terminal (meth)acrylate styrene-methyl (meth)acrylate copolymers, and other macromonomers. The content thereof is desirably 5.0 to 50.0 mass percent relative to the solid component during curing of the hardcoat liquid.

The above polymerizable component can be synthesized by known methods, or a commercially available product can be employed. The hardcoat liquid can contain a known photopolymerization initiator. The type and quantity of photopolymerization initiator employed are not specifically limited and can be suitably established.

The hardcoat liquid is prepared by mixing with the polymerizable component a solvent selected based on the SP value of the waterborne resin composition employed to form the primer layer. The quantity of solvent in the hardcoat liquid is normally about 30 to 90 mass percent of the total mass of the hardcoat liquid, but need only fall within a range yielding a viscosity permitting coating, and is not specifically limited.

The hardcoat liquid is coated on the primer layer, dried as needed, and then subjected to a curing treatment to form a hardcoat layer. A known coating method such as dipping or spin coating can be employed. The coating conditions can be suitably established so as to form a hardcoat layer of desired film thickness. The light that is irradiated can be, for example, an electron beam or ultraviolet radiation. The type and irradiation conditions of the light that is irradiated can be suitably selected based on the type of curable component employed. The thickness of the hardcoat layer that is formed is desirably about 0.5 to 10 μm from the perspective of scratch resistance.

As set forth above, the present invention makes it possible to obtain a highly durable eyeglass lens in which there is good adhesion between the hardcoat layer and primer layer, and the hardcoat layer does not peel off or separate during storage or use, by preparing a hardcoat liquid with a solvent selected based on the SP value of the waterborne resin composition used to form the primer layer.

As set forth above, in the eyeglass lens of the present invention, another layer can be present between the primer layer and the substrate. Examples of the other layer are a polarizing layer imparting polarizing performance and a photochromic layer imparting light-adjusting performance. Based on research by the present inventor, the waterborne resin composition is highly suited to coating on polarizing layers containing dichroic dyes. This is thought to be because since dichroic dyes are generally water soluble, they tend to be compatible with the waterborne resin composition. Accordingly, as an example of a desirable embodiment of the present invention, a polarizing layer is formed on the substrate and the primer layer is formed over the polarizing layer.

Normally, the polarizing performance of the polarizing layer is achieved by uniaxially orienting the dichroic dye. The practice of coating a polarizing layer coating liquid on a grooved surface is widely employed to uniaxially orient the dichroic dye in this fashion. The grooves can be formed on the surface of the substrate, but forming them on the surface of an orienting layer provided on the substrate as described in Patent References 1 to 3 is advantageous to developing good polarizing performance by the dichroic dye. Prior to forming the primer layer, it is desirable to treat the polarizing layer to render it water insoluble after coating and drying the coating liquid to enhance film stability. Further, the dichroic dye is desirably subjected to an immobilization treatment (the formation of a protective layer to immobilize the dye) to enhance film strength and stability. The immobilization treatment is desirably conducted after the water insolubilization treatment. The orientation of the dichroic dye within the polymerizing film can be immobilized by means of the immobilization treatment.

For details regarding polarizing lenses having an orientation layer and a polarizing layer containing a dichroic dye, reference can be made to the descriptions in paragraphs [0056] to [0100] and Examples of Published Japanese Translation (TOKUHYO) No. 2008-527401 of a PCT International Application; and paragraphs [0013] to [0024], [0026] to [0036], and Examples of Japanese Unexamined Patent Publication (KOKAI) No. 2009-237361. In the present invention, as well, an eyeglass lens having a polarizing layer between the primer layer and substrate can be manufactured based on the above descriptions. The contents of the above applications are expressly incorporated herein by reference in their entirety.

In the present invention, it is possible to form other functional films over the hardcoat layer. For example, when forming a functional film in the form of an antireflective film, a single layer or multiple layer film comprised of a known inorganic oxide can be used as the antireflective film. Examples of such inorganic oxides are silicon dioxide (SiO₂), zirconium oxide (ZrO₂), aluminum oxide (Al₂O₃), niobium oxide (Nb₂O₅), and yttrium oxide (Y₂O₃). The method of formation is not specifically limited. The thickness of the antireflective film is, for example, 0.1 to 5 μm. Additional functional films in the form of water repellent films, UV-absorbing films, IR-absorbing films, photochromic films, antistatic films, and the like can also be laminated on.

Since the eyeglass lens manufactured by the manufacturing method of the present invention as set forth above can have good adhesion between the primer layer and hardcoat layer, it can exhibit good durability for an extended period.

### EXAMPLES

The present invention will be further described based on Examples below. However, the present invention is not limited to the embodiments shown in Examples.

### 1. SP Values of Solvents

The solvents shown in Table 1 were candidates for hardcoat liquid preparation. The SP value of each solvent described in the known literature is given in Table 1.

TABLE 1

| Solvent | SP value |
|---|---|
| Methyl isobutyl ketone (MIBK) | 8.10 |
| Propyleneglycol monomethylether acetate | 8.73 |
| (PGMEA) | |
| Ethyleneglycol monoethylether acetate | 8.91 |
| (EGEEA) | |
| Propyleneglycol monomethylether (PGME) | 10.60 |
| Ethyleneglycol monoethylether (EGEE) | 11.47 |

### 2. Preparation of Waterborne Polyurethane Resin Composition and Measurement of SP Value

A Product named as Adeka Bontighter HUX-232 (an aqueous dispersion obtained by dispersing in water a terminal isocyanate prepolymer containing a carboxyl group and having a base skeleton in the form of a polyester polyol, solid component 30 mass percent, particle diameter of resin component less than 0.1 μm, 20 mPa·s viscosity at 25° C., pH 8.5 at 25° C.) made by ADEKA Corporation was diluted six-fold with PGM to prepare a waterborne polyurethane resin composition for use in forming a primer layer.

The SP value of the waterborne polyurethane resin composition prepared was measured by the above-described method at 11.0.

### 3. Fabrication of Polarizing Lens

(1) Forming the Orienting Layer

A polyurethane urea lens (product name Phoenix, made by HOYA Corporation, refractive index 1.53, with hardcoat, 70 mm in diameter, base curve 4, center thickness 1.5 mm) was employed as the lens substrate. A SiO₂ film was formed to a thickness of 0.2 μm by vacuum vapor deposition on the concave surface of the lens.

Abrasive-containing urethane foam (abrasive: Al₂O₃ particles with an average particle diameter of 0.8 μm, product name POLIPLA 203A, made by Fujimi Inc.; urethane foam: approximately the same shape as the curvature of the concave surface of spherical lens) was employed to subject the SiO₂ film that had been formed to uniaxial polishing under conditions of a rotational speed of 350 rpm at a polishing pressure of 50 g/cm² for 30 seconds. The polished lens was rinsed in pure water and dried.

(2) Formation of Polarizing Film

After drying the lens, 2 to 3 g of an aqueous solution of roughly 5 mass percent of water-soluble dichroic dye (trade name Varilight solution 2S, made by Sterling Optics, Inc.) was spin coated on the polished surface to form a polarizing film. In the spin coating, the aqueous solution of dye was fed at a rotational speed of 300 rpm, which was held for 8 seconds, after which a rotational speed of 400 rpm was held for 45 seconds, followed by 1,000 rpm held for 12 seconds.

Next, an aqueous solution with an iron chloride concentration of 0.15 M, a calcium hydroxide concentration of 0.2 M, and a pH of 3.5 was prepared. The lens obtained above was immersed for about 30 seconds in this aqueous solution, withdrawn, and thoroughly rinsed in pure water. This step rendered the originally water-soluble dye insoluble (water insolubilization treatment).

(3) Immobilization Treatment

Following (2) above, the lens was immersed for 15 minutes in a 10 mass percent aqueous solution of γ-aminopropyl triethoxysilane. It was then rinsed three times with pure water, heat treated for 30 minutes in a heating furnace (temperature within furnace: 85° C.), removed from the furnace, and cooled to ambient temperature.

After cooling, the lens was immersed for 30 minutes in a 2 mass percent aqueous solution of γ-glycidoxypropyl trimethoxysilane. Following the immobilization treatment, the lens was heat treated for 30 minutes in a heating furnace (temperature within furnace: 60° C.), removed from the furnace, and cooled to ambient temperature.

Following the above processing, the thickness of the polarizing film that was formed was about 1 μm.

(4) Formation of Waterborne Resin Layer (Primer Layer)

Following the above cooling treatment, the waterborne polyurethane resin composition was spin coated on the surface of the polarizing film. The spin coating was conducted by feeding the composition onto the polarizing film at a rotational speed of 100 rpm for 10 seconds, followed by 400 rpm for 10 seconds and 1,000 rpm for 30 seconds.

Following the spin coating, the lens was dried for 30 minutes in a heating furnace (temperature within furnace: 60° C.) to remove the moisture, thereby forming a primer layer (waterborne polyurethane resin layer) over the polarizing film. The thickness of the primer layer formed was 0.30 μm.

The film characteristics of the waterborne polyurethane resin composition employed as measured by the above methods were: a glass transition temperature Tg of −18° C., a pencil hardness of H, and a tensile strength of 49 MPa.

(5) Formation of Hardcoat Layer

A coating liquid obtained by mixing 1,000 mass parts of dipentaerythritol hexaacrylate (Kayarad DPHA, made by Nippon Kayaku Co., Ltd.), 3000 mass parts of the solvent shown in Table 1, and 30 mass parts of photopolymerization initiator (Irgacure819, made by Ciba Japan) was applied by spin coating (1,000 rpm maintained for 30 seconds) to a lens that had been subjected to the processing of (4) above. Following coating, curing was conducted with a UV radiation irradiating device at a UV irradiation level of 1,200 mJ/cm², yielding a hardcoat 4.5 μm in thickness.

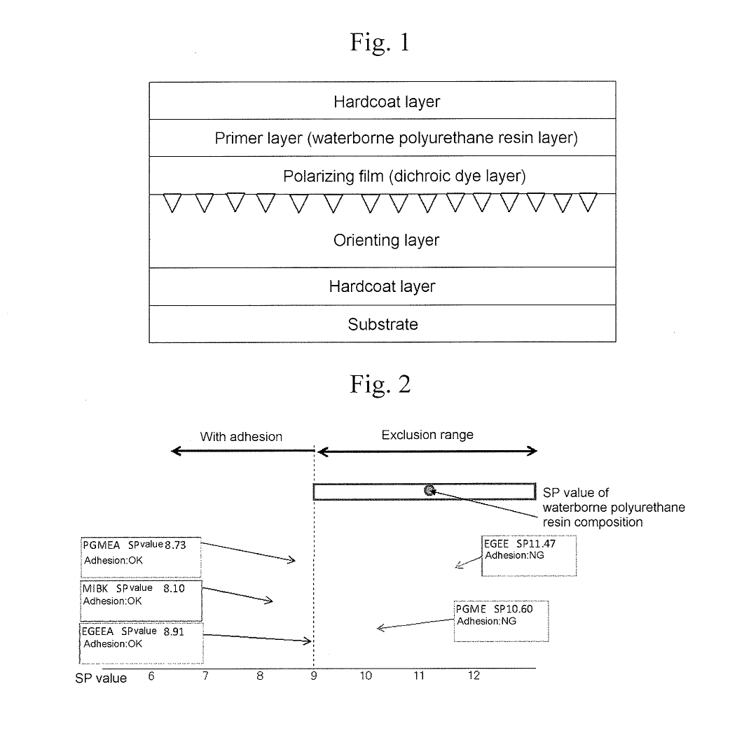

A total of three polarizing lenses having the layer configuration shown in FIG. 1 were prepared by the above steps.

### 4. Evaluation Methods

(1) Evaluation of Initial Adhesion

The adhesion of the lenses was evaluated by the following method immediately following fabrication.

### <Adhesion Evaluation Method>

Crosscuts were made at intervals of 1.5 mm in the hardcoat layer to form a grid comprised of 100 squares. Adhesive tape (cellophane tape made by Nichiban K. K.) was strongly adhered to the spots where the crosscuts had been made, after which the adhesive tape was rapidly pulled away. Then, the number of squares separated among the 100 squares of cured film was counted. The evaluation scale was as follows:

### (Evaluation Scale)

◯ Number of squares that separated: 0 to 2/100
□ A Number of squares that separated: 3 to 5/100
X Number of squares that separated: 6 or more

### (2) Adhesion After Warm Water Resistance Test

Various polarizing lenses that had been prepared using different solvents were immersed for 24 hours in 50° C. warm water, dried, and evaluated for adhesion of the polarizing lens by the above method.

(3) Adhesion After Humidity Resistance test

The various polarizing lenses of Examples and Comparative Examples were stored for 168 hours in an environment of 40° C. and 90 percent RH and then evaluated for adhesion of the polarizing lens by the above method.

The above results are given in Table 2.

TABLE 2

| | | | Adhesion | |
|---|---|---|---|---|
| | | | after | Adhesion |
| | | Adhesion | warm | after |
| | Hardcoat | immediately | water | humidity |
| | liquid | following | resistance | resistance |
| | solvent | fabrication | test | test |
| Lens 1 | MIBK | ◯ | ◯ | ◯ |
| Lens 2 | PGMEA | ◯ | ◯ | ◯ |
| Lens 3 | EGEEA | ◯ | ◯ | ◯ |
| Lens 4 | PGME | X | X | X |
| Lens 5 | EGEE | X | X | X |

### Evaluation Results

As shown in Table 2, lenses 4 and 5 exhibited low adhesion of the hardcoat film and primer layer immediately after fabrication, after warm water resistance test, and after humidity resistance test. By contrast, lenses 1 to 3 exhibited good adhesion in all of the evaluations. Observation of the portions of the hardcoat layers of lenses 4 and 5 that separated in adhesion evaluation revealed that the primer layer had remained in the separated portions. This indicated that the cause was not adhesion between the primer layer and polarizing layer, but separation due to poor adhesion between the hardcoat layer and primer layer.

FIG. 2 shows the relation between the SP value of the solvent employed to prepare the hardcoat liquid and the SP value of the waterborne polyurethane resin composition employed to form the primer layer. From FIG. 2, it can be determined that the use of a solvent having an SP value within a range close to the SP value of the waterborne polyurethane resin composition resulted in a drop in adhesion of the hardcoat layer, and the use of a solvent having an SP value outside the above range clearly tended to result in good adhesion of the hardcoat layer. In that case, as shown in FIG. 2, it was possible to form a hardcoat layer with good adhesion to the primer layer by setting an exclusion range of “SP1±2” based on the SP value of the waterborne polyurethane resin composition (SP1).

The above results indicated that an eyeglass lens with good adhesion between the primer layer and hardcoat layer could be manufactured by selecting a solvent for use in preparing the hardcoat liquid based on the SP value of the waterborne resin composition used to form the primer layer.

The present invention is useful in the field of manufacturing various eyeglass lenses such as polarizing lenses.

1. A method of manufacturing an eyeglass lens comprising a primer layer and a hardcoat layer in this order on a substrate, which comprises:
coating a waterborne resin composition in which a resin component is dispersed or dissolved in a water-based solvent on the substrate and then removing the water-based solvent to form the primer layer; and
directly coating a hardcoat liquid comprising a curable component and a solvent on the primer layer that has been formed and then conducting a curing process to form the hardcoat layer; and further comprises:
setting an exclusion range including solubility parameter SP 1 of the waterborne resin composition and utilizing a solvent having a solubility parameter outside the exclusion range that has been set for preparing the hardcoat liquid.

2. The method of manufacturing an eyeglass lens according to claim 1, wherein a solvent having a solubility parameter that is lower than the exclusion range is utilized as the solvent for the preparation of the hardcoat liquid.

3. The method of manufacturing an eyeglass lens according to claim 1, wherein the exclusion range is set to a range of SP1±X, wherein 1≦X≦2.

4. The method of manufacturing an eyeglass lens according to claim 1, wherein the curable component is a photo-curable component and the curing process is conducted by irradiation with light.

5. The method of manufacturing an eyeglass lens according to claim 1, wherein a polarizing layer is formed on the substrate and then the primer layer is formed on the polarizing layer.
